(19) United States
(12) Patent Application Publication
(10) Pub. No.: US 2014/0067511 A1
(43) Pub. Date: Mar. 6, 2014

(54) System and Method for Providing Mobile Prepaid/Loyalty Programs

(71) Applicants: Tomás Vitorino de Castro Froes, Lisbon (PT); Hugo Miguel Ribeiro Silveira da Cunha, Oeiras (PT); Sérgio Rui de Silva Agostinho, Lisbon (PT); Nizarali Micail Venturini Casimiro de Badrudino, Loures (PT)

(72) Inventors: Tomás Vitorino de Castro Froes, Lisbon (PT); Hugo Miguel Ribeiro Silveira da Cunha, Oeiras (PT); Sérgio Rui de Silva Agostinho, Lisbon (PT); Nizarali Micail Venturini Casimiro de Badrudino, Loures (PT)

(21) Appl. No.: 13/597,514

(22) Filed: Aug. 29, 2012

(51) Int. Cl. G06Q 30/02

(52) U.S. Cl. CPC G06Q 30/0233; G06Q 20/322
USPC 705/14.33

(57) ABSTRACT

A network communications system is provided for operating a loyalty points or pre-paid value program. The system may include, but is not limited to, a retail device that provides machine-readable encoded information representing a uniform resource identifier and transaction information, and that receives redemption information from a customer device. The system may also include a remote server, that supports the loyalty points/pre-paid value program for many retailers. The server may be associated with the uniform resource identifier, and be configured to receive the transaction information from the customer device, and to transmit the redemption information to the customer device. The customer does not need to download any specific customer application to participate in the program.

The invention relates generally to a communications system for providing or implementing a loyalty program, a pre-paid program (for goods or services), or the like, especially with the use of one or more mobile devices.

Various systems have been developed to facilitate marketing and sales transactions and to develop customer loyalty. A restaurant, for example, may provide a loyalty punch card to a customer, to encourage the customer to visit the restaurant, with the promise of a free meal, or some other discount, after having visited a certain number of times. As another example, a store may provide a coupon on the back of a receipt, to encourage the customer to return to the store with the promise of a discount on a future purchase.

United States Patent Application Publication No. 2011/0307318 refers to a system wherein loyalty code data is electronically transferred to or acquired by a customer. The data may be encoded into a QR (Quick Response) image, which may be scanned by the customer, using a hand-held mobile device. Points accumulated by the customer may be redeemed by engaging in communications with a third party. The entire disclosure of United States Patent Application Publication No. 2011/0307318 is incorporated herein by reference.

The known systems are overly complicated and cumbersome, especially with respect to redemption of loyalty points and pre-paid transactions. The present invention overcomes to a great extent the various problems and deficiencies associated with the known systems.

### SUMMARY

The present invention relates to a system and method for managing and conducting prepaid services and loyalty programs. The system can be implemented and operated without downloading any specific customer application to a mobile device. According to one aspect of the invention, a customer uses his or her mobile device (e.g., a smartphone) to interact with a technological shortcut, such as by scanning a QR image, interacting via NFC (Near Field Communication), or using some other proximity-enabled technology, to interact with a remote computer platform.

According to another aspect of the invention, a customer may collect and redeem loyalty points (or pre-paid value). Points may be collected from a variety of devices, including, for example, a television screen, and a fruit juice container. Likewise, points may be redeemed (consumed) at a variety of locations and under different circumstances, including essentially anyplace where a smartphone or other proximity-enabled device can be operated. The points may have monetary value, and they may bought directly or acquired through consumer purchases. Moreover, they may be exchanged for products or services.

In operation, when a customer desires to exchange money to credit a prepaid services account, the store may generate a QR image that is scanned by the customer's phone using a generic QR reader. Then, a mobile page is displayed in the customer's browser with confirmation of the transaction, including the credit to the customer's account. The account may be created using any of the various single-click sign-on methods available, providing a simplified and gratifying experience for users.

To redeem accumulated loyalty points to acquire products or services, the customer may go to the store's catalogue using his or her mobile device interne browser and select one or more items available for a redemption transaction. After selecting one or more such items, a QR image is generated on the customer's mobile device, and that image is then scanned by the store's device, which may be mobile or fixed. The scanning operation triggers the necessary redemption processing to be performed which, upon completion and algorithmic validation, enables the store to confirm that the redemption transaction was successful. If desired, the customer may be notified through a push message that the transaction was successful.

Thus, according to one embodiment of the invention, a network system is provided for operating a loyalty points or pre-paid value program. The network system may have, among other things, a device for providing machine-readable encoded information (e.g., embodied in a QR image) representing a uniform resource identifier and transaction information. A receiving device (e.g., a QR-enabled communications device) may be employed to receive redemption information from a customer device. A server may be located remote from the display device, and may be associated with the uniform resource identifier. The server receives the transaction information from the customer device, and transmits the redemption information to the customer device (where the redemption information can then be transferred to the receiving device).

According to another embodiment of the invention, a programmed method is performed by (1) causing a first device to provide machine-readable encoded information representing a uniform resource identifier and transaction information, (2) permitting a second device (e.g., a mobile customer device) to receive the encoded information from the first device, (3) causing a server, remote from the first device, and associated with the uniform resource identifier, to receive the transaction information from the first device, and to transmit redemption information to the second device, and (4) causing the first device to receive encoded information from the second device, and to thereby receive the redemption information. If desired, steps (1)-(4) may be performed in the order listed.

### BRIEF DESCRIPTION OF DRAWINGS

FIG. 1 is a block diagram of a mobile system, including at least two mobile (customer and retail hand-held) devices, constructed in accordance with an embodiment of the invention;

FIG. 2 is a top view of the mobile devices of FIG. 1, engaged in a points transfer process;

FIG. 3 is a flow diagram for the points transfer process of FIG. 2, showing steps performed by the customer mobile device;

FIG. 4 is a schematic illustration of the retail mobile device at successive stages of the points transfer process;

FIG. 5 is another top view of the mobile devices of FIG. 1, where the devices are engaged in a points redemption process;

FIG. 6 is a flow diagram of the points redemption process, showing steps performed by the customer mobile device;

FIG. 7 is a schematic illustration of the retail mobile device at successive stages of the points redemption process;

FIG. 8 is a block diagram of a mobile system, including at least one mobile device and an electronic device with a display screen, constructed in accordance with another embodiment of the invention;

FIG. 9 is a front view of the electronic device of FIG. 8; and

FIG. 10 is a block diagram of a mobile system, including at least one mobile device and one or more packages (physical objects), constructed in accordance with yet another embodiment of the invention.

### DETAILED DESCRIPTION

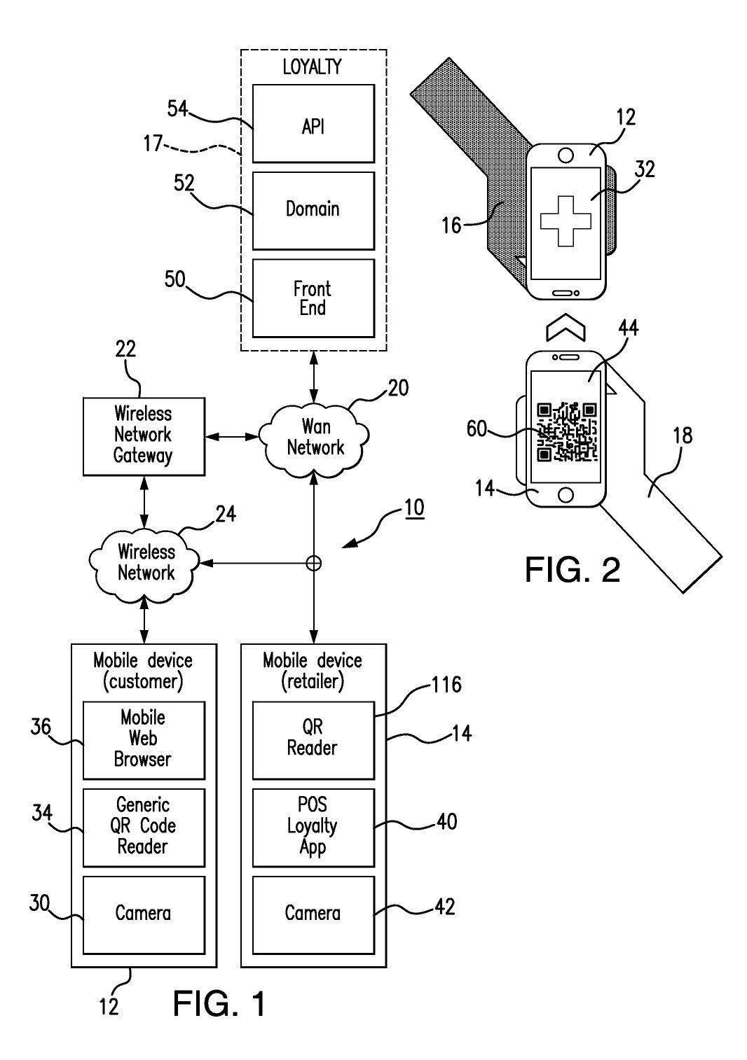

Referring now to the drawings, where like reference numerals designate like elements, there is a shown in FIG. 1 a mobile system 10 constructed in accordance with an embodiment of the invention. The system 10 includes a customer mobile device 12, a retail device 14, and a loyalty server 17. The customer device 12 may be carried by hand in and out of the retail store (not illustrated) by a customer 16 (FIG. 2). The retail device 14 may be located in the store (or in some other marketing location). The retail device 14 may be a hand-held mobile device carried by a salesperson 18. Alternatively, the retail device 14 may be at a fixed location, such as at a sales desk (not illustrated).

The loyalty server 17 (FIG. 1) may be located at a remote location (remote from the customer and the store). The server 17 may communicate with the customer device 12 and the retail device 14 through various wireless connections, including, but not limited to, a WAN (Wide Area Network), such as the global internet 20, a wireless network gateway 22, and a wireless network 24. The wireless connections may include, if desired, a cellular radio access network, a WiFi network (IEEE 802.11), and/or a WiMax network (IEEE 802.16).

The customer device 12 has, among other things, a camera 30, a display 32 (FIG. 2), a generic QR image reader 34 (FIG. 1), and a mobile web browser 36. The camera 30, the display 32, the reader 34, and the browser 36 are configured to operate on a suitable mobile software platform such as, but not limited to, iPhone OS, Android OS, Palm WebOS, J2ME, Windows Mobile, Flash, or Flash Mobile.

The retail device 14 has a point-of-sale loyalty application 40 (FIG. 1), a camera 42, and a display device 44 (FIG. 2). The loyalty application 40 may be downloaded from the loyalty server 17, long before (several hours or days before) the customer device 12 enters the store. The application 40, the camera 42, and the display device 44 may be operated on a suitable mobile software platform such as the ones identified above in connection with the customer device 12.

The loyalty server 17 (FIG. 1) is configured to communicate with and conduct and record transactions with a large number of customer and retail devices 12, 14. The server 17 has a front end device 50 that faces the customers and the retailers (through the wireless connections 20, 22, 24), a web-based operating unit 52 for inputting and receiving information to and from the front end device 50, and an API (Application Programming Interface) 54 that faces a user (not illustrated), by which the user can control the operating unit 52.

The customer and retail devices 12, 14 and the server 17 may be provided with suitable data storage and power supply devices (not illustrated).

In operation, the customer 16 is engaged by the salesperson 18 (or encounters marketing information). The customer 16 then enters into a marketing or sales transaction, and receives marketing information, a bill or invoice, or a sales receipt. During or at the conclusion of the transaction, the customer 16 is provided access to a machine-readable QR image 60 (FIG. 2) that encodes information as determined by the loyalty application 40 (FIG. 1), according to a predetermined pre-paid services/loyalty program coordinated by the user of the loyalty server 17.

The QR image 60 (FIG. 2) may be displayed on the display device 14, 44, or the image 60 may be printed on marketing materials, the invoice, the bill, or the receipt. Instead of the QR image 60, the encoded information, generated by the loyalty application 40, may be embodied in some other two-dimensional barcode such as DataMatrix, ShotCode, High Capacity Color Barcode or Microsoft Tag, or a one-dimensional barcode, or some other type of machine-readable coded image.

The QR image 60 (or other graphical image) is captured (photographed) by the camera 42. The camera 42 transmits the corresponding image data to the QR reader 34, which decodes the information that was encoded into the QR image 60. The encoded information may be a string of alphanumeric data that contains (1) a URI (Uniform Resource Identifier), which may be in the form of a URL (Uniform Resource Locator), such as a world wide web address, and (2) transaction information.

The mobile web browser 36 of the customer device 12 uses the URI to open a web site that is maintained by the loyalty server 17. The customer 16 then uses his or her device 12 to sign on to the web site (or be signed on automatically), and then the device 12 communicates the transaction information to the loyalty server 17 via the web site interface. The transaction information, when communicated to the loyalty server 17, causes the loyalty server 17 to credit a predetermined quantity of redeemable loyalty points (or pre-paid value) to the customer's account, to be accumulated by the customer 16, for example.

The loyalty points may be functionally related to the value of products and/or services purchased by the customer 16, or the frequency with which the customer 16 uses the system 10. Alternatively, the loyalty points may represent money (pre-paid value) submitted by the customer 16 to the retailer, such that the loyalty account constitutes a pre-paid account for use in future purchases of goods or services.

An important simplifying aspect of the illustrated embodiment is that the system 10 can be used by the customer 16 who has the generic QR code reader 34 and the web browser 36. The customer 16 does not need to download any special loyalty program application such as a native mobile loyalty application. When the loyalty code (encoded in the QR image 60) is presented to the customer 12, the customer 12 takes a picture (30) of the image 60, and the loyalty code information is then extracted by the generic QR code reader 34. The extracted information includes the URI that permits opening of the loyalty program web site and the processing of the corresponding transaction information.

In operation, the extracted URI is used by the generic QR code reader 34 to navigate the web browser 36 to the web site that is maintained by the loyalty server 17. At some point, transaction settlement information, concerning the loyalty transaction, including the customer's name, the time and date of the transaction, the amount of points transferred and accumulated, etc. may be transferred from the loyalty server 17 to the store (18). The transfer of settlement information, however, may occur long after (if desired, several hours or days after the customer leaves the store). The illustrated system 10 does not require any real time communication between the retail device 14 and the loyalty server 17.

At the end of the marketing or sales transaction, the loyalty server 17 may cause a confirmation message to be communicated to the customer device 12. Alternatively, communication between the customer device 12 and the loyalty server 17 may be deferred until long after (several hours or days after) the transaction has taken place. The illustrated system 10 does not require any real time communication between the mobile devices 12, 14 and the server 17 to occur during the time of the marketing or sales transaction.

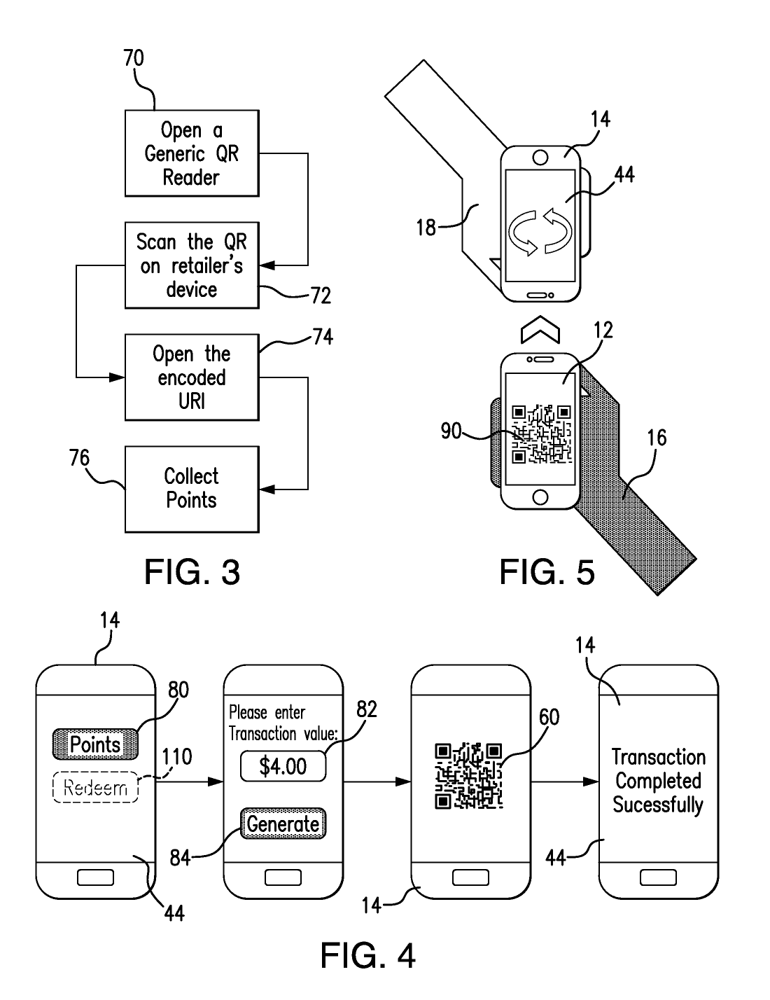

The operation of the customer device 12 during the points transfer operation is illustrated in FIG. 3. The customer device 12 opens the generic QR reader 34 (70), scans the QR image 60 that is displayed on the retail device 14 (72), uses the browser 36 to access the web site identified by the encoded URI (74), uses the web site (36) to transmit the transaction information to the loyalty server 17, 52, and receives the confirmation message (76). The confirmation message may indicate to the customer 16 how many loyalty points are credited to his or her account, and the corresponding information may be stored in a relational database in a storage device associated with the server 17.

As illustrated in FIG. 4, the retail device 14 initiates a points award process by receiving a signal that points are to be awarded. The signal may be generated when the salesperson 18 actuates a “points” button 80 on the display 44. The salesperson 18 then inputs a transaction value into a space 82 on the display 44, and actuates a “generate” button 84, which causes the device 14 to generate the QR image 60 as a function of the transaction value and other predetermined factors relating to the loyalty program.

The QR image 60 is then captured by the customer device 12 as described above. If desired, feedback may be provided to the retail device 14 from the customer device 12 and/or the loyalty server 17, causing the retail device 14 to remove the QR image 60 from the display device 44 and to indicate to the salesperson 18 that the transaction was successfully completed.

The manner in which the URI and the transaction information are encoded in and decoded from the QR image 60, and processed and transmitted to the loyalty server 17, resulting in a credit to the customer's loyalty account, may be as described in United States Patent Application Publication No. 2011/0307318.

Instead of using the QR image 60, the customer and retail devices 12, 14 may have NFC (Near Field Communication) capability, for NFC transmittal of the encoded information from the retail device 14 to the customer device 12. In other words, rather than photographing the QR image 60, the customer device 12 may be held close to the NFC pad of the retail device 14 to allow the customer device 12 to receive the encoded information from the retail device 14. The operation of the NFC-enabled system may otherwise be the same as that of the system 10 described above.

Points Redemption Process:

Referring now to FIG. 5, an important aspect of the illustrated system 10 is that the same customer device 12 that captures the QR image 60 from the retail device 14 may be configured to generate and display a QR image 90 for redemption, to be captured by the retail device 14. The customer device 12 can display the redemption QR image 90 without having any specific customer application downloaded thereto.

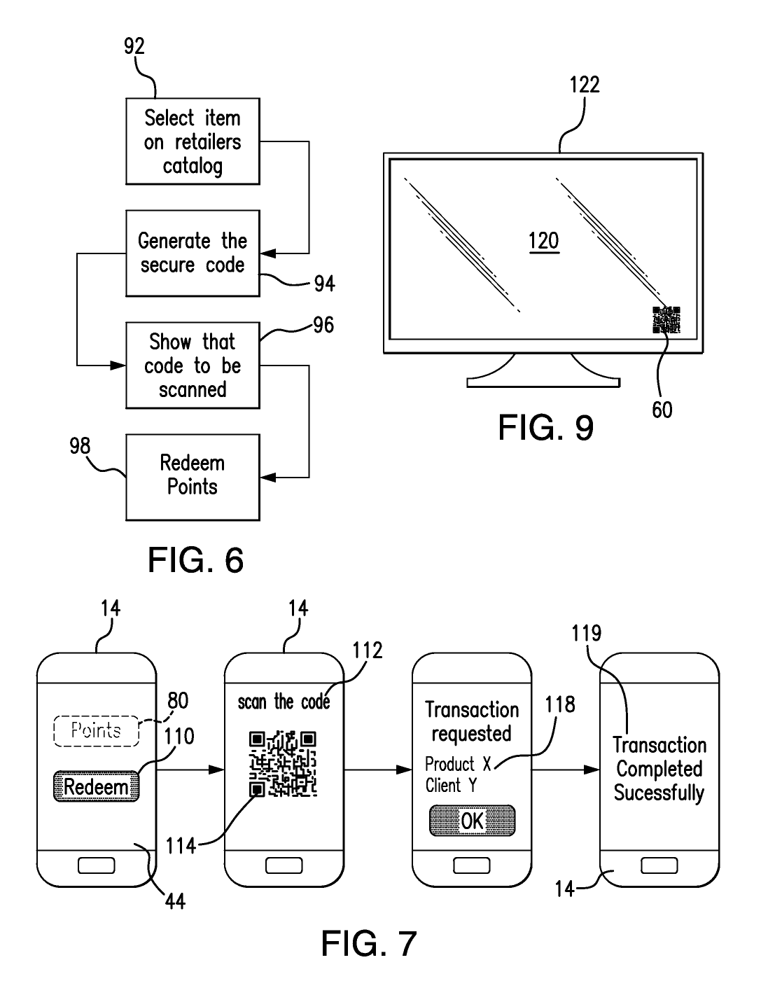

In operation, referring now to FIG. 6, the customer 16 selects an item from the retailer catalogue (92). The catalogue may be accessed through the retailer web site, maintained by or associated with the loyalty server 17. The web site may be accessed via the customer device 12 by scanning an appropriate QR code from the retail device 14. Alternatively, the catalogue may be located and accessed using an all-purpose internet search engine, such as Google, Bing or Yahoo! Search. From the mobile web site, the customer 16 can determine how many points are in his or her loyalty account, and locate a product or service that can be purchased by redeeming accumulated points (or pre-paid value).

The customer device 12 then generates a QR image 90 that securely encodes the product to be purchased (94). The QR image 90 need not contain any information about the amount of points to be redeemed or the identity of the customer, although that information may be displayed (32) on the device 12 if desired. The customer 16 then shows the QR image 32, 90 to the salesperson 18 (96). The salesperson 18 uses his or her device 14, 42 to scan the image 90, and the retail device 14 then displays (44) the product or service to be purchased. The salesperson 18 then provides the product or service to the customer 16 (98).

As illustrated in FIG. 7, the retail device 14 may be prompted to perform a redemption process by selecting a “redeem” button 110 on the device display 44. Next, the salesperson 18 is prompted (112) to take a picture of the QR image 90 on the customer device 12. If desired, a shadow version 114 of the QR image 90 may be displayed on the retail device 14 to provide visual confirmation to the salesperson 18 that the redemption QR image 90 has been captured (photographed).

The retail device 14 has a QR reader 116 (FIG. 1) that decodes the information encoded in the redemption QR image 90. Based on the decoded information, the device 14 displays (118, FIG. 7) the product (or service) that the customer 16 wishes to acquire by redeeming points (or pre-paid value). The salesperson 18 provides the product or service to the customer 16, and then provides appropriate feedback to the retail device 14, causing the retail device 14 to display a confirmation message 119 that the redemption process was successfully completed.

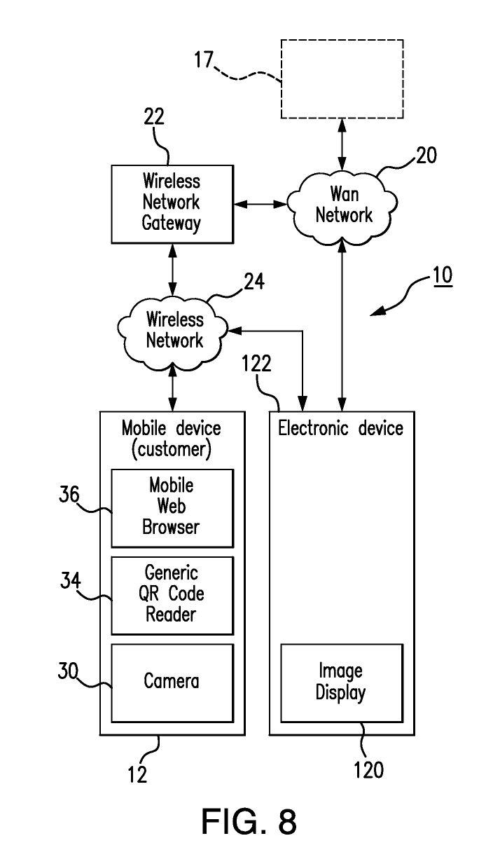

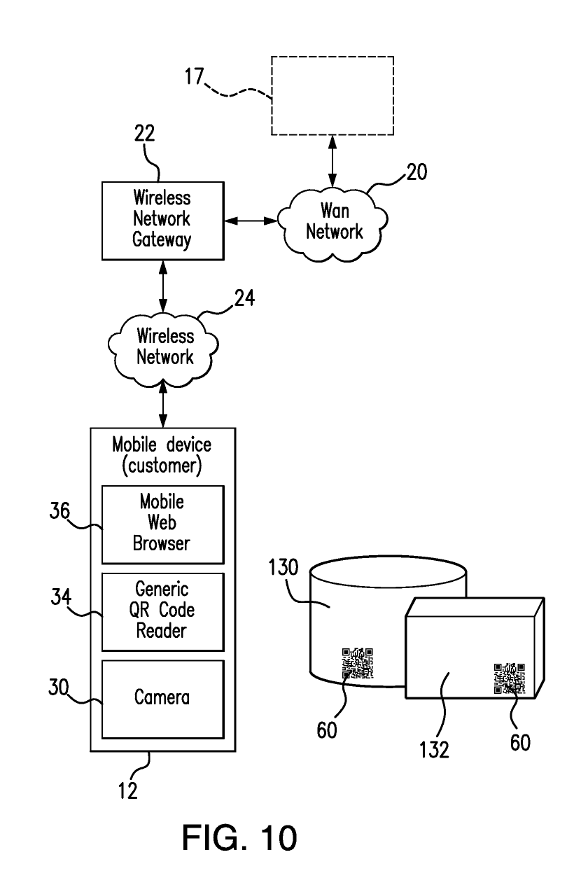

As illustrated in FIGS. 8 and 9, the customer device 12 may be used to accumulate points from a variety of locations, including from the display screen 120 of a television 122 (or a computer, a movie theater, a Jumbotron, another electronic device, etc.) during a broadcast, especially during a commercial sponsored by the retailer. An appropriate QR image 60 may be displayed by the retailer on the television, computer or other suitable screen 120. Alternatively, as illustrated in FIG. 10, the QR image 60 may be affixed to or printed on a physical object, such as a beverage container 130, a cardboard package 132, etc.

If desired, the retail device 14 does not need to communicate with the loyalty server 17 until long after (several hours or days after) the customer 16 has left the store. At the later time, the retail device 14 may communicate all of the necessary information, including the redemption information, to the server 17, which then settles and records the redemption transaction.

While this disclosure has been particularly shown and described with references to exemplary embodiments thereof, it will be understood by those skilled in the art that various changes in form and details may be made therein without departing from the scope of the embodiments encompassed by the appended claims.

1. A network system for operating a loyalty points or pre-paid value program, the network system comprising:
an encoded-information providing device for providing machine-readable encoded information representing a uniform resource identifier and transaction information;
a redemption-information receiving device for receiving redemption information from a customer device;
a server, remote from the redemption-information receiving device, and associated with the uniform resource identifier, for receiving the transaction information from the customer device, and for transmitting the redemption information to the customer device; and
a network device for connecting the server to the customer device.

2. The system of claim 1, further comprising a retail device, and wherein the encoded-information providing device and the redemption-information receiving device are incorporated into the retail device.

3. The system of claim 2, wherein the retail device is a hand-held electronic device configured for wireless communication.

4. The system of claim 2, wherein the retail device is configured to display a QR image, and wherein the QR image has the machine-readable information encoded therein.

5. The system of claim 4, wherein the server maintains a web site that is associated with the uniform resource identifier.

6. The system of claim 5, wherein the server stores information concerning a customer account associated with or identified by the customer device, and wherein the transaction information includes information concerning loyalty points to be credited to the customer account.

7. The system of claim 5, wherein the server stores information concerning a customer account associated with or identified by the customer device, and wherein the transaction information includes information concerning pre-paid value.

8. The system of claim 6, wherein the redemption information identifies a product or service to be acquired by redeeming loyalty points.

9. The system of claim 7, wherein the redemption information identifies a product or service to be acquired based on pre-paid value.

10. The system of claim 1, wherein the encoded-information providing device is an electronic device that has a display screen.

11. The system of claim 1, wherein the encoded-information providing device includes a physical object.

12. A method of operating a marketing program over an electronic communications network, the method comprising the steps of:
causing a first device to provide machine-readable encoded information representing a uniform resource identifier and transaction information;
permitting a second device to receive the encoded information from the first device, the second device being a mobile device;
causing a server, remote from the first device, and associated with the uniform resource identifier, to receive the transaction information from the second device, through the electronic communications network, and to transmit redemption information to the second device; and
causing the first device to receive encoded information from the second device, and to thereby receive the redemption information.

13. The method of claim 12, further comprising the step of encoding the information that is permitted to be received by the second device and the information that is received by the first device into first and second graphical images, respectively.

14. The method of claim 13, wherein the graphical images include first and second two-dimensional QR (Quick Response) images.

15. The method of claim 12, further comprising the step of communicating the information that is permitted to be received by the second device and the information that is received by the first device via NFC (Near Field Communication).

16. The method of claim 12, wherein the first and second devices are hand-held wireless communication devices.

17. The method of claim 16, wherein the redemption information identifies a product or service to be acquired by redeeming loyalty points or based on pre-paid value.

18. A machine-readable information storage medium having information stored therein for implementing a method of operating a loyalty points or pre-paid value program over an electronic communications network, wherein the method comprises the steps of:
causing a retail device to provide machine-readable encoded information representing a uniform resource identifier and transaction information;
permitting a mobile customer device to receive the encoded information from the retail device;
causing a server, remote from the retail device, and associated with the uniform resource identifier, to receive the transaction information from the mobile customer device, through the electronic communications network, and to transmit redemption information to the mobile customer device; and
causing the retail device to receive encoded information from the mobile customer device, and to thereby receive the redemption information.
